(19) United States
(12) Patent Application Publication
(10) Pub. No.: US 2024/0185345 A1
(43) Pub. Date: Jun. 6, 2024

(54) COMPRESSION OF PRICE CHANGE DATA

(71) Applicant: Chicago Mercantile Exchange Inc., Chicago, IL (US)

(72) Inventor: Seo Wook Jang, Jersey City, NJ (US)

(73) Assignee: Chicago Mercantile Exchange Inc., Chicago, IL (US)

(21) Appl. No.: 18/441,547

(22) Filed: Feb. 14, 2024

Related U.S. Application Data
(63) Continuation of application No. 17/697,522, filed on Mar. 17, 2022, now Pat. No. 11,941,694.
Application No. 17/697,522 is a continuation of application No. 14/587,467, filed on Dec. 31, 2014, now Pat. No. 11,315,181.

(51) Int. Cl. G06Q 40/04; G06F 16/2457; G06Q 40/00

(52) U.S. Cl. CPC G06Q 40/04; G06F 16/24575; G06F 16/24578; G06Q 40/00

(57) ABSTRACT

A computer system compresses value change data. Value change ranges are identified for value changes corresponding to different times. Codes are selected based on the identified value change ranges. The ranges are adjusted in response to the occurrence of a stop condition. The value change range codes are concatenated with machine-coded categories and stored.

### REFERENCE TO RELATED APPLICATIONS

This application is a continuation under 37 C.F.R. § 1.53(b) of U.S. patent application Ser. No. 17/697,522 filed Mar. 17, 2022, now U.S. Pat. No. ______, which is a continuation under 37 C.F.R. § 1.53(b) of U.S. patent application Ser. No. 14/587,467 filed Dec. 31, 2014, now U.S. Pat. No. 11,315,181, the entire disclosures of which are each incorporated by reference in their entirety.

### BACKGROUND

Numerous types of financial products are routinely traded on financial exchanges. When processing orders to trade such products, it may be desirable to validate prices contained in those orders relative to historic price activity. Such price validation may also be desirable when settling various types of financial products. Validating prices against raw historic price data can consume significant data processing resources, however. Such raw historic price data may also consume significant data storage resources. For these and other reasons, there remains a need for improved methods and systems for compressing price data.

### SUMMARY

This Summary is provided to introduce a selection of concepts in a simplified form that are further described below in the Detailed Description. This Summary is not intended to identify key features or essential features of the invention.

In some embodiments, a computer system may calculate a price change value for each of times t(m,1) through t(m,N) for which there is data representing a price value. The times t(m, 1) through t(m,N) may be during a time frame F(m). The computer system may identify, for each of the times t(m, 1) through t(m, N) for which a price change value is calculated, a price change category corresponding to a range of price changes that includes that price change value. Each identified category may be a member of a group of price change categories, with each of the price change categories in the group corresponding to a different range of price changes. The computer system may select, from a code table comprising codes for each of multiple different combinations of price change categories, a code for time frame F(m) corresponding to the price change categories identified for the times t(m, 1) through t(m,N). The computer system may store the code selected for time frame F(m). The computer system may then repeat these steps for multiple iterations, each iteration corresponding to a different value of m and a successively later time frame.

In some embodiments, a computer system may calculate a price change ΔP(q). The price change ΔP(q) may correspond to a time t(q) and be based on a difference between a price corresponding to the time t(q) and a price corresponding to a previous time t(q−1). The computer system may identify a price change category for ΔP(q). The identified category may be a member of a group of price change categories, with each of the price change categories in the group corresponding to a different range of price changes, and with the price change category identified for ΔP(q) corresponding to a range of price changes that includes ΔP(q). The computer system may store a code corresponding to the price change category identified for ΔP(q). The computer system may repeat these steps for multiple iterations, with each iteration corresponding to a successively incremented value of q and a successively later time.

Embodiments include, without limitation, herein-described methods for compressing and/or otherwise processing price data, computer systems configured to perform such methods, and non-transitory computer-readable media storing instructions executable by a computer system to perform such methods.

### BRIEF DESCRIPTION OF THE DRAWINGS

Some embodiments are illustrated by way of example, and not by way of limitation, in the figures of the accompanying drawings and in which like reference numerals refer to similar elements.

FIG. 1 shows an exemplary trading network environment for implementing systems and methods according to some embodiments.

FIG. 2 is a time line showing times, time frames, and data for trading activities associated with a hypothetical financial product.

FIGS. 3A and 3B are a flow chart showing operations performed by a computer system executing an algorithm according to some embodiments.

FIG. 4 is a code table according to some embodiments.

FIG. 5 is an example of a graph that may be created and displayed based on codes generated and stored according to some embodiments.

FIG. 6 is a flow chart showing operations performed by a computer system executing an algorithm according to some additional embodiments.

FIG. 7 is a time line showing a relationship, according to some embodiments, between times for which price data is compressed and times from which price data is used to compute a parameter used in the compression.

FIG. 8 is a flow chart showing additional operations performed by a computer system according to some embodiments.

### DETAILED DESCRIPTION

In the following description of various embodiments, reference is made to the accompanying drawings, which form a part hereof, and in which various embodiments are shown by way of illustration. It is to be understood that there are other embodiments and that structural and functional modifications may be made. Embodiments of the present invention may take physical form in certain parts and steps, examples of which will be described in detail in the following description and illustrated in the accompanying drawings that form a part hereof.

Various embodiments may comprise a method, a computer system, and/or a computer program product. Accordingly, one or more aspects of one or more of such embodiments may take the form of an entirely hardware embodiment, an entirely software embodiment, and/or an embodiment combining software and hardware aspects. Furthermore, such aspects may take the form of a computer program product embodied as one or more non-transitory computer-readable storage media having computer-readable program code, or instructions, stored in or on that media. The term “computer-readable medium” or “computer-readable storage medium” as used herein includes not only a single medium or single type of medium, but also a combination of one or more media and/or types of media. Such a non-transitory computer-readable medium may store computer-readable instructions (e.g., software) and/or computer-readable data (i.e., information that may or may not be executable). Any suitable computer readable media may be utilized, including various types of non-transitory computer readable storage media such as hard disks, CD-ROMs, optical storage devices, magnetic storage devices, FLASH memory, and/or any combination thereof. The term “computer-readable medium” or “computer-readable storage medium” could also include an integrated circuit or other device having hard-coded instructions (e.g., logic gates) that configure the device to perform one or more operations.

Aspects of method steps described in connection with one or more embodiments may be executed by one or more processors associated with a computer system (such as but not limited to exchange computer system 100 described below). As used herein, a “computer system” could be a single computer or could comprise multiple computers. When a computer system comprising multiple computers performs a method, various steps could be performed by different ones of those multiple computers. Processors of a computer system may execute computer-executable instructions stored on non-transitory computer-readable media. Embodiments may also be practiced in a computer system forming a distributed computing environment, with tasks performed by remote processing devices that are linked through a communications network. In a distributed computing environment, program modules may be located in both local and remote computer storage media including memory storage devices.

### Exemplary Operating Environment

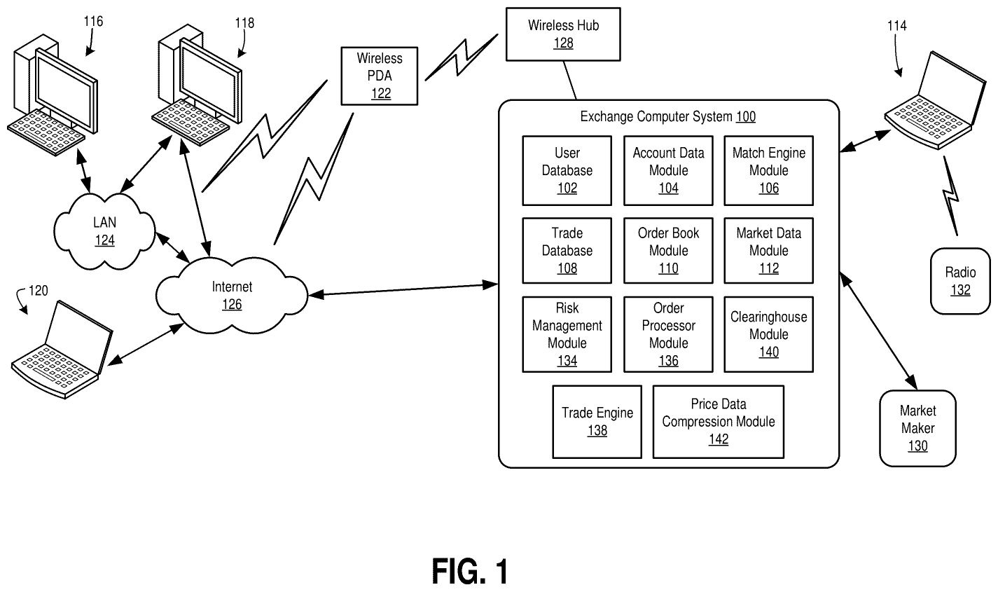

Aspects of at least some embodiments can be implemented with computer systems and computer networks that allow users to communicate trading and other information. An exemplary trading network environment for implementing systems and methods according to some embodiments is shown in FIG. 1. The implemented systems and methods can include systems and methods, such as are described herein, that facilitate data processing and other activities associated with compressing price data.

Computer system 100 can be operated by a financial product exchange and configured to perform operations of the exchange for, e.g., trading and otherwise processing data relating to various financial products. Financial products of the exchange may include, without limitation, futures contracts, options on futures contracts, other types of options, and other types of derivative contracts. Financial products traded or otherwise processed by the exchange may also include over-the-counter (OTC) products such as OTC forwards, OTC options, OTC swaps, etc. Financial products traded through the exchange may also or alternatively include other types of financial interests, including without limitation stocks, bonds and/or other securities (e.g., exchange traded funds), foreign currencies, and spot market trading of commodities.

Computer system 100 receives orders for financial products, matches orders to execute trades, transmits market data related to orders and trades to users, and performs other operations associated with a financial product exchange. Exchange computer system 100 may be implemented with one or more mainframe, desktop or other computers. In one embodiment, a computer device uses a 64-bit processor. A user database 102 includes information identifying traders and other users of exchange computer system 100. Data may include user names and passwords. An account data module 104 may process account information that may be used during trades. A match engine module 106 is included to match prices and other parameters of bid and offer orders. Match engine module 106 may be implemented with software that executes one or more algorithms for matching bids and offers.

A trade database 108 may be included to store information identifying trades and descriptions of trades. In particular, a trade database may store information identifying the time that a trade took place and the contract price. An order book module 110 may be included to store prices and other data for bid and offer orders, and/or to compute (or otherwise determine) current bid and offer prices. A market data module 112 may be included to collect market data, e.g., data regarding current bids and offers for futures contracts, futures contract options, and other derivative products. Module 112 may also prepare the collected market data for transmission to users. A risk management module 134 may be included to compute and determine a user's risk utilization in relation to the user's defined risk thresholds. An order processor module 136 may be included to decompose delta based and bulk order types for further processing by order book module 110 and match engine module 106.

A clearinghouse module 140 may be included as part of exchange computer system 100 and configured to carry out operations of a clearinghouse of the exchange that operates computer system 100. Module 140 may receive data from and/or transmit data to trade database 108 and/or other modules of computer system 100 regarding trades involving futures contracts and other financial products traded through the exchange that operates system 100. Clearinghouse module 140 may facilitate the financial product exchange (or a clearinghouse of the exchange) acting as one of the parties to every traded contract or other product. For example, computer system 100 may match an offer by party A to sell a futures contract, an option, or other exchange-traded financial product with a bid by party B to purchase a like exchange-traded financial product. Module 140 may then create an exchange-traded financial product between party A and the exchange clearinghouse and a second exchange-traded financial product between the exchange clearinghouse and party B. Module 140 may similarly create offsetting contracts when creating contracts as a result of an option exercise and/or may select option grantors to fulfill obligations of exercising option holders. Module 140 may also be configured to perform other clearinghouse operations. As a further example, module 140 may maintain performance bond data with regard to clearing members and/or trading customers. As part of such operations, module 140 may store and maintain data regarding the values of various futures contracts and other interests, determine mark-to-market and final settlement amounts, confirm receipt and/or payment of amounts associated with performance bond accounts, confirm satisfaction of delivery and other final settlement obligations, etc. Module 140 may also perform data processing operations associated with settling and clearing of financial products that were not traded through exchange computer system 100. Examples of such products include OTC forwards, swaps, and other products that may be executed bilaterally between the parties and subsequently submitted to an exchange for clearing and/or other processing.

Exchange computer system 100 may include a price data compression module 142. Various operations performed by module 142 in at least some embodiments are further described below.

Each of modules 102 through 142 could be implemented as separate software components executing within a single computer, separate hardware components (e.g., dedicated hardware devices) in a single computer, separate computers in a networked computer system, or any combination thereof (e.g., different computers in a networked system may execute software modules corresponding more than one of modules 102-142). When one or more of modules 102 through 142 are implemented as separate computers in a networked environment, those computers may be part of a local area network, a wide area network, and/or multiple interconnected local and/or wide area networks.

Exchange computer system 100 may also communicate in a variety of ways with devices that may be logically distinct from computer system 100. For example, computer device 114 is shown directly connected to exchange computer system 100. Exchange computer system 100 and computer device 114 may be connected via a T1 line, a common local area network (LAN), or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124 and may communicate with exchange computer system 100 via LAN 124. LAN 124 may implement one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics, radio links, or other media.

A wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish, or any other device for connecting a computer device to the Internet. Computers 116, 118, and 120 may communicate with each other via the Internet 126 and/or LAN 124.

One or more market makers 130 may maintain a market by providing continual bid and offer prices for a derivative, security, or other type of product to exchange computer system 100. Exchange computer system 100 may also include trade engine 138. Trade engine 138 may, e.g., receive incoming communications from various channel partners and route those communications to one or more other modules of exchange computer system 100.

One skilled in the art will appreciate that numerous additional computers and systems may be coupled to exchange computer system 100. Such computers and systems may include, without limitation, additional clearing systems, regulatory systems, and fee systems.

The operations of computer devices and systems shown in FIG. 1 and described herein may be controlled by computer-executable instructions stored on one or more non-transitory computer-readable media. For example, computer device 116 may include computer-executable instructions for receiving market data from exchange computer system 100 and displaying that information to a user. As another example, module 142 and/or other modules of exchange computer system 100 may include one or more non-transitory computer-readable media storing computer-executable instructions for performing herein-described operations associated with compressing and/or otherwise processing price data.

Of course, numerous additional servers, computers, handheld devices, personal digital assistants, telephones, and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

In at least some embodiments, exchange computer system 100 (or “computer system 100”) receives, stores, generates, and/or otherwise processes data associated with market activity related to a financial product. In at least some embodiments, computer system 100 compresses price data associated with a financial product. In particular, computer system 100 accesses data that indicates prices for a financial product at each of multiple times, generates data representing changes in prices, and stores codes representing that generated price change data. The codes may require substantially less storage resources than the initial price data but retain relevant information that may be used for subsequent price validation and for other purposes. Processing of the codes when performing price validation and/or other operations may also consume fewer data processing resources than would be needed to perform those operations using the initial price data.

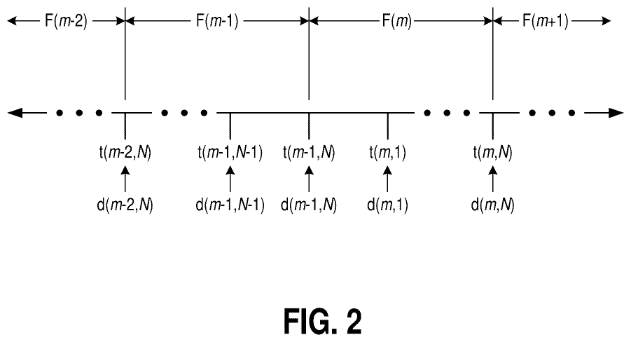

FIG. 2 is a time line showing times, time frames, and data for trading activities associated with a hypothetical financial product A and that will be used as an example to describe certain embodiments. Financial product A may be a type of futures contract, a type of option, a type of OTC forward, a type of OTC option, a type of security, or other type of financial product. In FIG. 2 and throughout this specification (including the claims), an italicized lowercase letter represents a counter variable (or “counter”) having values that, either alone or as part of an arithmetic expression, distinguish between instances of multiple similar elements. For example, “m” is used as a counter in connection with time frames F. The expression F(1), for example, is equivalent to F(m=1), with time frame F(1) being different from time frame F(2). “F(m)” represents the m^{th} time frame F, the expression “F(m−1)” represents the time frame F immediately preceding F(m), the expression “F(m+1)” represents the time frame F immediately following F(m), etc. As another example, “n” is used as a counter to distinguish between times t in a particular time frame F. The n^{th} time in the m^{th} time frame is represented as t(m,n).

Also in FIG. 2 and throughout this specification (including the claims), italicized uppercase letters represent values that remain constant. For example, each time frame F in FIG. 2 includes N times t. In the example of FIG. 2, each time frame F corresponds to a different calendar week, each time t corresponds to a weekday (e.g., one of Monday, Tuesday, Wednesday, Thursday or Friday), and N=5. In other embodiments, times t and time frames F may correspond to different time intervals and N may have a different value. For example, each time frame F may correspond to a particular trading day, each time t may correspond to a particular hour during a particular day, and N may equal 8.

For each of multiple times t throughout multiple time frames F in the example of FIG. 2, a data value d regarding product A trading is stored. Data value d corresponding to the nth time in the m^{th} time frame is represented by d(m,n). In the example of FIG. 2 each data value d indicates either (i) a close of day trading price for instances of product A, or (ii) that no trade price data is available. With regard to possibility (ii), no price data may be available if, e.g., the day corresponding to a particular time t was a holiday or if markets were otherwise closed. With regard to possibility (i), in other embodiments price data may represent another value (e.g., average bid-ask midpoint over a portion of a period corresponding to time t).

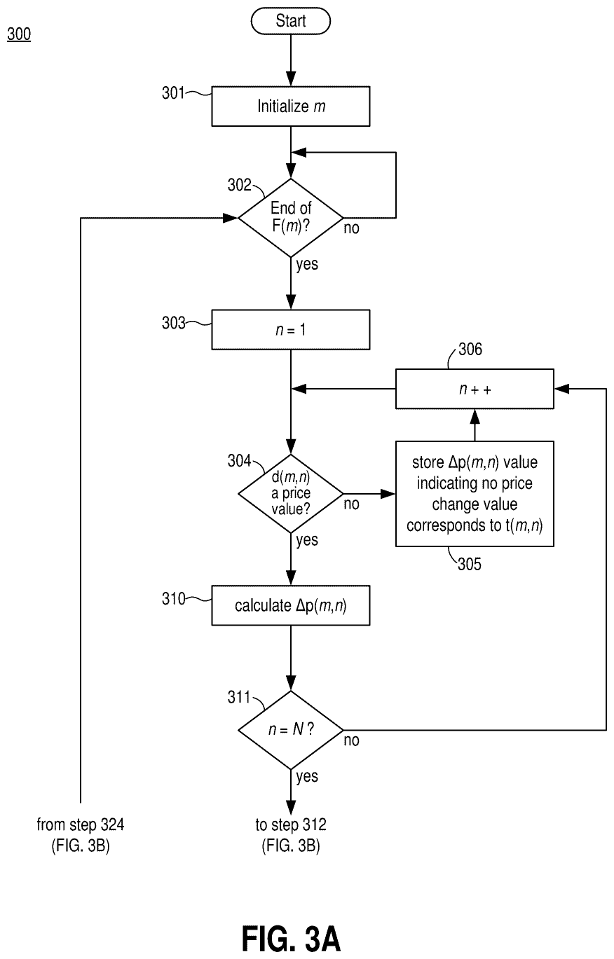

FIGS. 3A and 3B are a flow chart showing operations in an algorithm 300 performed by computer system 100, according to some embodiments, in connection with compressing price data such as may be contained in data values d in FIG. 2. In some embodiments, the operations in FIGS. 3A and 3B may be performed by price data compression module 142. In other embodiments, however, some or all of these operations may be performed by other modules of computer system 100 and/or by modules of one or more other computer systems.

Beginning in step 301 (FIG. 3A), module 142 initializes the m counter by, e.g., setting m=1. In step 302, module 142 determines if the end of time frame F(m) has been reached. If not, and as shown by the “no” branch, step 302 is repeated until the end of time frame F(m) has occurred. If the end of time frame F(m) has been reached, and as shown by the “yes” branch, module 142 continues to step 303 and initializes the n counter.

In step 304, module 142 analyzes data value d(m,n) corresponding to time t(m,n). In particular, module 142 evaluates whether data value d(m,n) is a price corresponding to time t(m,n) or whether data value d(m,n) indicates that there is no price corresponding to time t(m,n). If data value d(m,n) is a price, and as shown by the “yes” branch, module 142 proceeds to step 310. In step 310, module 142 calculates a price change value Δp(m,n) representing an amount by which the price corresponding to time t(m,n) has changed relative to the most recent previous time t for which there was also a corresponding price. In some embodiments, module 142 calculates a price change value as an absolute value of a difference between the price corresponding to time t(m,n) and the price corresponding to the most recent previous time t for which there was a corresponding price.

The following is an example of operations performed in connection with step 310 according to some embodiments. If t(m,n) is t(m,1) in FIG. 2, module 142 would determine whether data value d(m−1,N) corresponding to time t(m−1,N) is a price or an indication that there is no price corresponding to time t(m−1,N). If data element d(m−1,N) is a price, then module 142 calculates a price change value for time t(m, 1) as the absolute value of the difference between the prices d(m,1) and d(m−1,N), i.e., Δp(m,n)=|d(m,1)−d(m−1,N)|. If data value d(m−1,N) indicates there is no price corresponding to time t(m−1,N), module 142 determines whether data value d(m−1,N−1) corresponding to time t(m−1, N−1) is a price or an indication that there is no price corresponding to time t(m−1,N−1). If data value d(m−1,N−1) is a price, then module 142 calculates Δp(m,n)=|d(m,1)−d(m−1,N−1)|. If data value d(m−1,N−1) indicates there is no price corresponding to time t(m−1, N−1), then each of d(m−1,N−2), etc., would be checked until a price is found, with Δp(m,n) then calculated as Δp(m,n)=|d(m,1)−<found price>|.

In other embodiments, module 142 may calculate a price change without computing an absolute value, or in some other manner.

After calculating Δp(m,n) in step 310, module 142 continues to step 311 and determines whether n equals N. If so, and as indicated by the “yes” branch, module 142 continues to step 312 (FIG. 3B). Step 312 is described below. If n does not equal N, and as indicated by the “no” branch from step 311, module 142 continues to step 306. In step 306, the n counter is incremented by 1, and module 142 then repeats step 304.

If module 142 determines in step 304 that data value d(m,n) indicates that there is no price corresponding to time t(m,n), and as shown by the “no” branch from step 304, module 142 continues to step 305. In step 305, module 142 stores a Δp(m,n) value indicating that there is no price change value corresponding to time t(m,n). Module 142 then continues from step 305 to step 306.

As mentioned above, module 142 continues to step 312 upon determining in step 311 that n equals N. In step 312, and as seen in FIG. 3B, module 142 resets the n counter to 1. Module 142 then continues to step 313 and determines whether the Δp(m,n) value is a price change value (see above discussion of step 310) or an indication that there is no price change value corresponding to time t(m,n) (see above discussion of step 305). If Δp(m,n) is a price change value, and as indicated by the yes branch from step 313, module 142 continues to step 320.

In step 320, module 142 identifies a price change category corresponding to the price change value Δp(m,n). In some embodiments, module 142 performs step 320 by accessing data storing a table of price change categories. Each of the categories in the table may correspond to a different range of possible price change values. Module 142 may identify the category corresponding to the price change value Δp(m,n) by identifying the category corresponding to the range that includes Δp(m,n). Upon identifying a price change category, module 142 stores the value of the identified category, which category corresponds to time t(m,n), as C(m,n).

The following is an example of operations performed in connection with step 320 according to some embodiments. If the price change value Δp(m,n) is 2.87, and if the price change categories are as shown below in Table 1, module 142 would identify category 2.

TABLE 1

| price change | range of price |
|---|---|
| category | change values |
| 1 | 0 ≤ price change < 1.5 |
| 2 | 1.5 ≤ price change < 3 |
| 3 | 3 ≤ price change |

From step 320, module 142 continues to step 321 and determines if n is equal to N. If so, and as indicated by the “yes” branch, module 142 continues to step 322. Step 322 is discussed below. If n does not equal N, and as shown by the “no” branch, module 142 continues from step 321 to step 315. In step 315, the n counter is incremented by 1 and module 142 then repeats step 313.

If module 142 determines in step 313 that data value Δp(m,n) indicates that there is no price change value corresponding to time t(m,n), and as indicated by the “no” branch from step 313, module 142 continues to step 314. In step 314, module 142 stores a C(m,n) value indicating that there is no category corresponding to time t(m,n). From step 314, module 142 continues to step 315.

As mentioned above, module 142 continues to step 322 upon determining that n equals N. In step 322, module 142 selects a code for time frame F(m). The selected code corresponds to the price change categories identified for the times t(m, 1) through t(m,N). In at some embodiments, module 142 selects a code from a code table that comprises a separate code for each of multiple different combinations of price change categories, for each of multiple different combinations of price change categories and absence of price change category for one or more times, and for the absence of price change categories for all times. As can be appreciated from the above discussion of steps 320 and 314, data values C(m,1) through C(m,N) indicate all the categories that may have been identified in connection with frame F(m), as well as the number of times t during time frame F(m) for which a category may not have been identified. In at least some embodiments, the code table includes a different code for all possible combinations of category(ies) and absence(s) of a category that could be indicated by the C(m,1) through C(m,N) values.

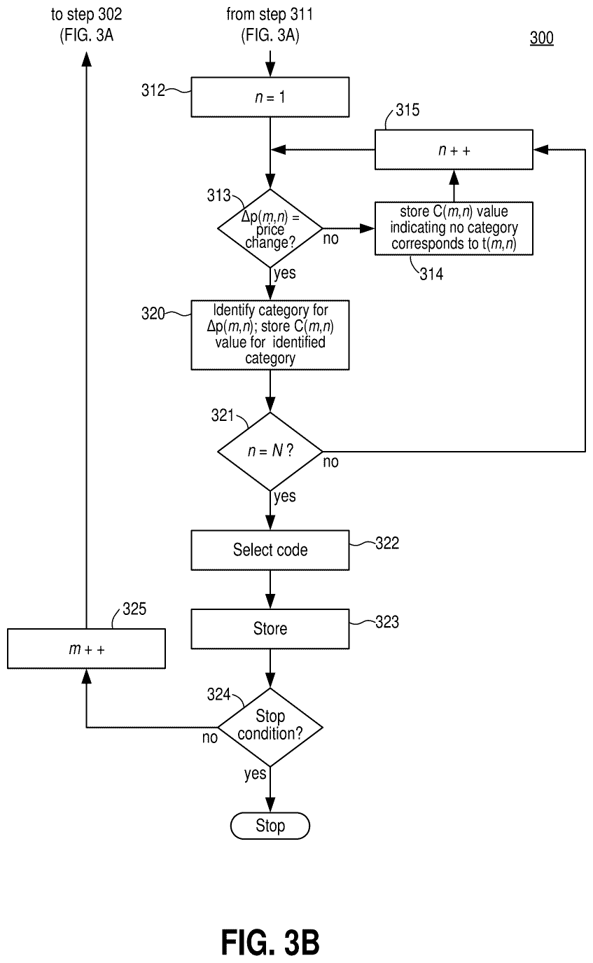

The total number of combinations in a code table that includes all possible combinations of category(ies) and absence(s) of category would be equal to

$$\frac{( J + N ) !}{J ! N !} ,$$

where J is the total number of categories and Nis the number of times in each time frame. In an embodiment in which N equals 5 (see above discussion of FIG. 2) and J equals 3 (see Table 1), the code table would include 56 entries. FIG. 4 is an example of a code table 400 according to such an embodiment. Each row in table 400 corresponds to a different combination of identified categories and/or absence of identified categories. Each category is described in the second field of the row, with the number after “C1:” indicating the number of times t in a time frame for which category 1 was identified, with the number after “C2:” indicating the number of times t in a time frame for which category 2 was identified, and with the number after “C3:” indicating the number of times t in a time frame for which category 3 was identified. The number of times in a time frame for which no category was identified can be derived by summing the C1, C2 and C3 numbers and subtracting that sum from N (with N=5 in the present example). For example, row 32 corresponds to a combination of category 1 identified for 1 time t in a time frame F, category 2 identified for two times t in that time frame F, category 3 identified for 1 time t in that time frame F, and no category identified for one time t in that time frame F. The code that would be selected for this combination is “BF.”

Table 2 provides several examples of codes that would be selected from table 400 based on various combinations of C(m,1) through C(m,N) values, with “<none>” used in Table 2 to represent a data value indicating absence of a corresponding category.

TABLE 2

| Example C(m, 1) through C(m, N) values | Code |
|---|---|
| C(m, 1) = <none>; C(m, 2) = 1; | AY |
| C(m, 3) = 1; C(m, 4) = 3; C(m, 5) = 1 | |
| C(m, 1) = 3; C(m, 2) = 1; C(m, 3) = | AY |
| <none>; C(m, 4) = 1; C(m, 5) = 1 | |
| C(m, 1) = 1; C(m, 2) = 1; C(m, 3) = 2; | AO |
| C(m, 4) = 1; C(m, 5) = 2 | |
| C(m, 1) = <none>; C(m, 2) = | AV |
| <none>; C(m, 3) = <none>; | |
| C(m, 4) = <none>; C(m, 5) = 3 | |
| C(m, 1) = 3; C(m, 2) = 3; C(m, 3) = 2; | BZ |
| C(m, 4) = 3; C(m, 5) = 1 | |

As seen in the first two rows of Table 2, the codes in the embodiment of code table 400 do not depend on the order in which categories or absences of categories appear in a particular combination. When trade price change statistics are reconstructed from such codes, and as described below, only the number of occurrences of categories or absences of categories are provided. Although this results in some loss of information, it allows greater efficiency by storing information most relevant for certain purposes. For example, the precise order of times in which trade prices may have changed by certain amounts during a particular time period may be less important, for purposes of price validation, than the number of times that price changes were within a certain range. In some embodiments, a code table might include multiple entries for a particular combination so as to permit reconstruction of the order in which price changes corresponding to certain categories occurred.

Returning to FIG. 3B, after selecting a code in step 322, module 142 stores that code in step 323. In some embodiments, module 142 stores that code by appending it to a code previously stored for the preceding time frame F. In step 324, module 142 determines if a stop condition has occurred. In some embodiments, for example, module 142 may be configured to periodically reset parameters of algorithm 300 if a value for counter m has incremented beyond a certain value. As another example, module 142 may be configured in some embodiments to periodically interrupt execution of algorithm 300 and prompt an operator of computer system 100 for input indicating whether execution should continue for further iterations. If a stop condition has occurred, and as shown by the “yes” branch from step 324, module 142 stops performing algorithm 300. If a stop condition has not occurred, and as shown by the “no” branch, module 142 continues to step 325, increments the m counter by 1, and returns to step 302 to start a new iteration of algorithm 300.

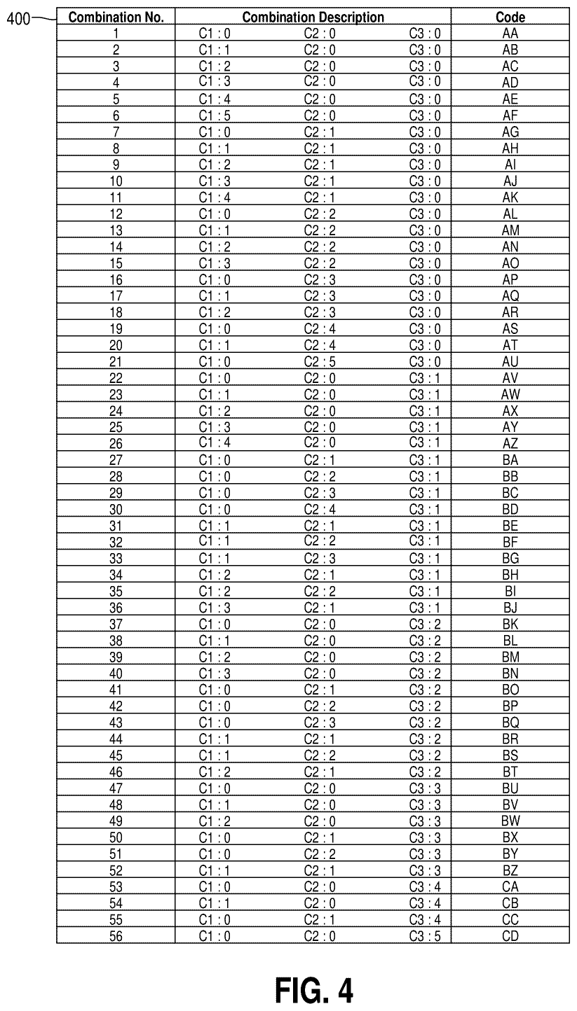

FIG. 5 is an example of a graph 500 that may be created and displayed based on codes stored by module 142 during operations shown in FIGS. 3A and 3B. The example of graph 500 assumes that code table 400 was used to store a set 501 of appended codes. Computer system 100 may create graph 500 by sequentially reading codes from set 501, decoding the codes based on table 400, then generating vertical lines based on the combination of price change categories corresponding to each of the decoded codes.

For example, the rightmost portion of set 501 includes the code “AO” that corresponds to week 30. As seen in FIG. 4, code AO represents a combination, during a single time frame F, of three times t for which price change category 1 was identified and two times t for which price change category 2 was identified. Accordingly, the week 30 portion of graph 500 includes three lines indicating category 1 price change levels and two lines indicating category 2 price change levels. Other portions of set 501 can be decoded in a similar manner, as shown in FIG. 5, to generate portions of graph 501 representing weeks 29 through 1.

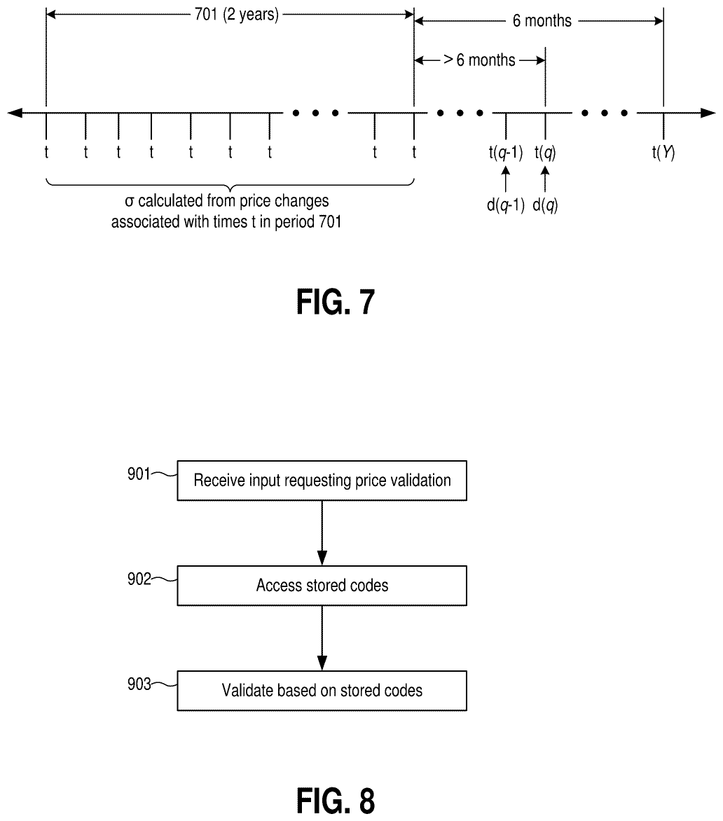

Graph 500 is only one example of a way in which compressed data resulting from algorithm 300 can be displayed. Other formats can be used, and data can be displayed for more or fewer time frames F. The compressed data resulting from algorithm 300 can also be used in other ways, as discussed below in connection with FIG. 8.

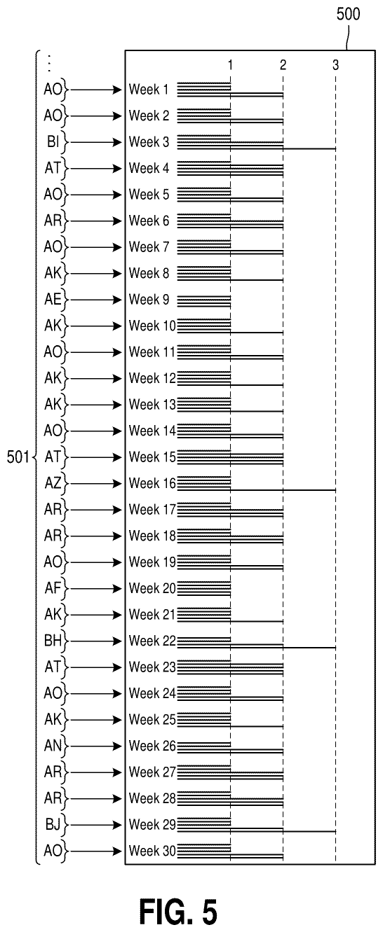

FIG. 6 is a flow chart showing operations in an algorithm 600 performed by module 142 according to some alternate embodiments. Similar to algorithm 300, algorithm 600 may be executed to compress price data by analyzing price data associated with a specific financial product, generating data based on that analysis, and storing codes based on that generated data. Unlike algorithm 300, however, times t are not grouped into time frames for purposes of algorithm 600. Instead, codes are selected for individual times t. Moreover, algorithm 600 is only performed with regard to times for which price data is available.

The counter q will be used to distinguish between different times t for purposes of algorithm 600. A data value associated with a time t(q), represented as d(q), may be a price corresponding to time t(q). As with algorithm 300, times t in algorithm 600 may correspond to different trading days, to different hours within trading days, or to other time periods.

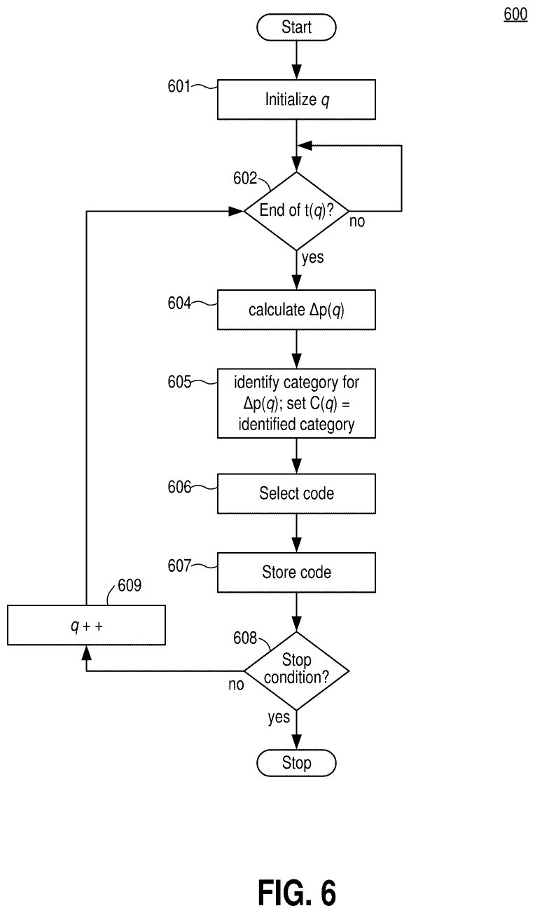

In some embodiments, price changes are categorized in algorithm 600 based on the relationship to a standard deviation calculated from price change values corresponding to previous times. The time period that includes those previous times may vary in different embodiments. As but one example, a standard deviation could be calculated based on price change values for times t over a two year preceding period. That standard deviation could then be recalculated at periodic intervals (e.g., every 6 months). This is shown in FIG. 7. In the example of FIG. 7, algorithm 600 is currently being performed with regard to time t(q). The standard deviation value σ used in algorithm 600 is a standard deviation of price changes corresponding to times t in a two year time span 701. Time t(q) is less than six months from the end of time period 701. At a subsequent time t(Y), the standard deviation σ is recalculated using price change values for times t in the two year period that ends on t(Y). That new value of σ is then used when algorithm 600 is performed with regard to times after t(Y) and before the next σ recalculation.

Turning to FIG. 6, module 142 initializes counter q in step 601. In step 602, module 142 determines if the end of time t(q) has been reached. If not, and as shown by the “no” branch, step 602 is repeated. If the end of time t(q) has been reached, and as shown by the “yes” branch, module 142 continues to step 604.

In step 604, module 142 calculates a price change value Δp(q) representing an amount by which the price corresponding to time t(q) (data value d(q)) has changed relative to the price corresponding to time t(q−1) (data value d(q−1)). In some embodiments, module 142 calculates a price change by subtracting the price corresponding to time t(q−1) from the price corresponding to time t(q), i.e., Δp(q)=d(q)−d(q−1). In other embodiments, module 142 may calculate a price change value as an absolute value, e.g., Δp(q)=|d(q)−d(q−1)|, or in some other manner.

Module 142 then continues from step 604 to step 605. In step 605, module 142 identifies a price change category corresponding to price change value Δp(q). In some embodiments, module 142 performs step 605 by accessing data storing a table of price change categories. Each of the categories in the table corresponds to a different range of possible price change values. Each of those ranges may be quantified in terms of a standard deviation value σ computed from price change values corresponding to times in a prior time period, as discussed above. Module 142 identifies the category corresponding to the price change value Δp(q) by identifying the category corresponding to the range that includes Δp(q). Upon identifying a price change category, which corresponds to time t(q), module 142 stores an indicator of that category as C(q).

The following is an example of operations performed in connection with step 605 according to some embodiments. If σ is 2.56, if Δp(q)=−4.8 (i.e., −1.880), and if the price change categories are as shown below in Table 3, module 142 would identify category 4 and store an indicator of category −1 as C(q).

TABLE 3

| price change | range of price |
|---|---|
| category | change values |
| −4 | price change < −4σ |
| −3 | −4σ ≤ price change < −3σ |
| −2 | −3σ ≤ price change < −2σ |
| −1 | −2σ ≤ price change < −σ |
| 0 | −σ ≤ price change < σ |
| 1 | σ ≤ price change < 2σ |
| 2 | 2σ ≤ price change < 3σ |
| 3 | 3σ ≤ price change < 4σ |
| 4 | 4σ ≤ price change |

From step 605, module 142 continues to step 606. In step 606, module 142 selects a code corresponding to C(q). In some embodiments having price change categories such as those set forth in Table 3, the codes may be binary digits as set forth in Table 4.

TABLE 4

| price change | |
|---|---|
| category | code |
| −4 | 1110 |
| −3 | 1100 |
| −2 | 1010 |
| −1 | 1000 |
| 0 | 0 |
| 1 | 1001 |
| 2 | 1011 |
| 3 | 1101 |
| 4 | 1111 |

The coding scheme of Table 4 offers several advantages. Because only one code begins with a zero, a single zero digit can be used for that code instead of multiple zero digits. By assigning that code to a +/−10 range of price change values, a single digit can be used for approximately 68% of all times t when price change values have a normal distribution. This may allow substantial reduction of memory requirements. With regard to the remaining codes, the least significant digit can be used to indicate if a code corresponds to a positive range of price change values (“1” for categories 1 through 4) or to a negative range of price change values (“0” for categories −1 through −4). In step 607, module 142 stores the code selected for time t(q).

In step 608, module 142 determines if a stop condition has occurred. For example, module 142 may be configured to determine if a new value for σ is available and if the code table used in step 605 must be updated. If a stop condition has occurred, and as shown by the “yes” branch from step 608, module 142 stops performing algorithm 600. If a stop condition has not occurred, and as shown by the “no” branch, module 142 continues to step 609, increments the q counter by 1, and returns to step 602 to start a new iteration of algorithm 600.

As with codes generated and stored during execution of algorithm 300, codes generated and stored during execution of algorithm 600 can be processed to generate various types of displays of the encoded information. Codes generated and stored during execution of algorithm 600 can also be used in other ways. FIG. 8 is a flow chart showing additional operations than can be performed by one or more modules of computer system 100 using codes stored in algorithm 300 or algorithm 600. In step 901, computer system 100 receives an input requesting price validation. That input may be, for example, an order for a financial product, which order may include a bid or ask price that must be validated against historical price levels. As another example, the input may be an indication that an instance of a financial product is to be settled, and validation of the settlement price may require validation against historical price levels.

In step 902, computer system accesses codes stored during performance of algorithm 300, algorithm 600, or a similar algorithm according to other embodiments. In step 903, the price associated with the input received in step 901 is validated based on categories corresponding to the accessed codes. Price validation can be performed in various manners. As but one example, and assuming codes have been stored for previous time frames F using algorithm 300, the input received in step 901 may include a subject price change that is in category 3. If stored data indicates that category 3 price changes have only occurred twice in the previous 90 day period or have not occurred at all in the previous 60 day period, the subject price change may be flagged as an abnormal price movement and instructions generated to recheck data from which the subject price change was calculated.

The above represents but one example. Numerous other criteria could be established for determining whether a price change is to be flagged as abnormal and data underlying that price change is to be subjected to further checking. Additional examples include, without limitation, the following:
Example I. A subject price change is flagged as abnormal if a category applicable to that subject price change applies to less than 5% of the last 90 days.
Example II. A subject price change is flagged as abnormal if a category applicable to that subject price change applies to less than 10 of the last 90 days AND applies to less than 3 of the last 10 days.
Example III. A subject price change is flagged as abnormal if less than 20 of the last 90 days AND less than 3 of the last 10 days have an applicable category that is either (a) the category applicable to that subject price change or (b) a category corresponding to price movement larger than the subject price change.

Additional embodiments include numerous variations on the exemplary features described thus far. As but one example, different numbers of categories may be available for use in performing operations such as those described in connection with step 320 (FIG. 3B) or step 605 (FIG. 6). Categories may also correspond to ranges of values different from the examples provided herein.

In addition to the embodiments described herein, embodiments include a computer system comprising at least one processor and at least one non-transitory memory. The at least one non-transitory memory may store instructions that, when executed, cause the computer system to perform operations that include (a) calculating a price change value for each of times t(m, 1) through t(m,N) for which there is data representing a price value, wherein the times t(m, 1) through t(m,N) are during a time frame F(m); (b) identifying, for each of the times t(m,1) through t(m,N) for which a price change value is calculated, a price change category corresponding to a range of price changes that includes that price change value, wherein each identified category is a member of a group of price change categories, wherein each of the price change categories in the group corresponds to a different range of price changes; (c) selecting, from a code table comprising codes for each of multiple different combinations of price change categories, a code for time frame F(m) corresponding to the price change categories identified for the times t(m,1) through t(m,N); (d) storing the code selected for time frame F(m); and (e) repeating (a) through (d) for multiple iterations, each iteration corresponding to a different value of m and a successively later time frame.

In some embodiments, the at least one non-transitory memory of the above-mentioned computer system may also or alternatively store instructions that, when executed, cause the computer system to perform operations that include (a) calculating a price change ΔP(q), wherein the price change ΔP(q) corresponds to a time t(q) and is based on a difference between a price corresponding to the time t(q) and a price corresponding to a previous time t(q−1); (b) identifying a price change category for ΔP(q), wherein the identified category is a member of a group of price change categories, wherein each of the price change categories in the group corresponds to a different range of price changes, and wherein the price change category identified for ΔP(q) corresponds to a range of price changes that includes ΔP(q); (c) storing a code corresponding to the price change category identified for ΔP(q); and (d) repeating (a) through (c) for multiple iterations, each iteration corresponding to a successively incremented value of q and a successively later time.

### Conclusion

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention.

1. A computer-implemented method including:
determining, by a processor, a specific price change for a product, the specific price change corresponding to a difference in price for the product at a start of a specific interval and at an end of the specific interval, the specific interval identified via a specific interval machine code;
establishing, by the processor and in a memory, a data structure the data structure including machine-coded price-change categories each identified via a respective change category machine code, each machine-coded price-change category corresponding to a respective price-change size range;
determining, after establishing the data structure and by the processor, that a stop condition for a range-determination algorithm has occurred;
adjusting, based on the stop condition and by the processor, a respective change size range for at least one of the machine-coded price-change categories;
determining, by the processor, a specific price change size range for the specific price change;
determining, by the processor and based on the specific price-change size range, to place the specific price change in a specific machine-coded price-change category from among the machine-coded price-change categories of the data structure;
committing, by the processor, the specific price change to the specific machine-coded category by concatenating the specific interval machine code with a specific price-change category machine code corresponding to the specific machine-coded price-change category to generate a specific price change code; and
storing, by the processor, the specific price change code within the data structure, thereby compressing price change data by storing price-change size range data in lieu of individual price-change size data.

2. The method of claim 1, further including determining that the specific price change for the product is abnormal.

3. The method of claim 2, wherein determination that the specific price change for the product is abnormal is performed in response to a validation request.

4. The method of claim 2, wherein determining that the specific price change for the product is abnormal includes determining an occupancy for the specific machine-coded price-change category.

5. The method of claim 4, wherein determining that the specific price change for the product is abnormal includes determining the occupancy is below a threshold number.

6. The method of claim 2, further including flagging, based on determining that the specific price change is abnormal, a transaction related to the specific price change.

7. The method of claim 6, further including initiating, based on the flagging, a recheck of the transaction.

8. The method of claim 1, wherein each price-change category machine code has an identical code length.

9. The method of claim 8, wherein the identical code length is different from a code length used for a machine code that indicates that no price change occurred within an interval.

10. The method of claim 1, wherein each price-change category machine code includes a binary code.

11. The method of claim 1, wherein each price-change category machine code indicates whether the corresponding machine-coded category includes positive ranges or negative ranges.

12. Non-transitory machine-readable media configured to store instructions thereon, the instructions configured to, when executed, cause a processor to:
determine a specific price change for a product, the specific price change corresponding to a difference in price for the product at a start of a specific interval and at an end of the specific interval, the specific interval identified via a specific interval machine code;
establish, in a memory, a data structure the data structure including machine-coded price-change categories each identified via a respective change category machine code, each machine-coded price-change category corresponding to a respective price-change size range;
determine, after establishing the data structure, that a stop condition for a range-determination algorithm has occurred;
adjust, based on the stop condition, a respective change size range for at least one of the machine-coded price-change categories;
determine a specific price change size range for the specific price change;
determine, based on the specific price-change size range, to place the specific price change in a specific machine-coded price-change category from among the machine-coded price-change categories of the data structure;
commit the specific price change to the specific machine-coded category by concatenating the specific interval machine code with a specific price-change category machine code corresponding to the specific machine-coded price-change category to generate a specific price change code; and
store the specific price change code within the data structure, thereby compressing price change data by storing price-change size range data in lieu of individual price-change size data.

13. The non-transitory machine-readable media of claim 12, wherein the instructions are further configured to cause the processor to determine that the specific price change for the product is abnormal.

14. The non-transitory machine-readable media of claim 13, wherein the instructions are further configured to cause the processor to determine that the specific price change for the product is abnormal in response to a validation request.

15. The non-transitory machine-readable media of claim 13, wherein the instructions are further configured to cause the processor to determine that the specific price change for the product is abnormal by determining an occupancy for the specific machine-coded price-change category.

16. The non-transitory machine-readable media of claim 15, wherein the instructions are further configured to cause the processor to determine that the specific price change for the product is abnormal by determining the occupancy is below a threshold number.

17. The non-transitory machine-readable media of claim 13, wherein the instructions are further configured to cause the processor to flag, based on determining that the specific price change is abnormal, a transaction related to the specific price change.

18. The non-transitory machine-readable media of claim 17, wherein the instructions are further configured to cause the processor to initiate, based on the flagging, a recheck of the transaction.

19. The non-transitory machine-readable media of claim 12, wherein each price-change category machine code includes a binary code.

20. A system including:
means for determining a specific price change for a product, the specific price change corresponding to a difference in price for the product at a start of a specific interval and at an end of the specific interval, the specific interval identified via a specific interval machine code;
means for establishing, in a memory, a data structure the data structure including machine-coded price-change categories each identified via a respective change category machine code, each machine-coded price-change category corresponding to a respective price-change size range;
means for determining, after establishing the data structure, that a stop condition for a range-determination algorithm has occurred;
means for adjusting, based on the stop condition, a respective change size range for at least one of the machine-coded price-change categories;
means for determining a specific price change size range for the specific price change;
means for determining, based on the specific price-change size range, to place the specific price change in a specific machine-coded price-change category from among the machine-coded price-change categories of the data structure;
means for committing the specific price change to the specific machine-coded category by concatenating the specific interval machine code with a specific price-change category machine code corresponding to the specific machine-coded price-change category to generate a specific price change code; and
means for storing the specific price change code within the data structure, thereby compressing price change data by storing price-change size range data in lieu of individual price-change size data.
